(19) United States
(12) Patent Application Publication
(10) Pub. No.: US 2008/0133639 A1
(43) Pub. Date: Jun. 5, 2008

(54) Client Statement of Health

(76) Inventors: Anatoliy Panasyuk, Bellevue, WA (US); Rajesh Kuppuswamy, Kirkland, WA (US); Doug S. Cavit, Arlington, WA (US)

Correspondence Address: MICROSOFT CORPORATION, ONE MICROSOFT WAY, REDMOND, WA, 98052, US

(21) Appl. No.: 11/565,402

(22) Filed: Nov. 30, 2006

(51) Int. Cl. G06F 15/16

(52) U.S. Cl. 709/201

(57) ABSTRACT

Client statement of health techniques are described herein. In an embodiment, a statement is generated that describes a relative health of a client's resources, such as hardware and/or software resources. The statement is exposed to a service provider over a network, which may be used to manage access of the client to one or more online services of the service provider.

### BACKGROUND

One of the most popular capabilities brought to the world by the Internet is the ability to conduct business between remote locations. For example, users may access financial accounts and conduct transactions by interacting with a bank that is located in another state (e.g., a “bill payer”), may “check in” for a flight, may buy or sell goods located across the globe, and so on. This access is attractive to both consumers and businesses, as businesses may reach a larger potential audience and consumers may have access to a wider range of services than those available locally to the user from traditional “bricks and mortar” stores.

Such network transactions, however, may result in increased exposure by both the consumer and the business to malicious parties. For example, viruses, “Trojans” and other malicious software (i.e., “malware”) are increasingly common on the Internet, which may lead to a significant risk of identity fraud and direct financial losses to both the consumers and the businesses. For instance, malicious software hidden on a consumer's computer may “snoop” keystrokes and therefore steal account numbers and passwords during legitimate access to an e-commerce web site.

Thus, consumers may suffer from problems with stolen identity and disputed transactions that may be both frustrating and financially damaging. Additionally, businesses involved with the disputed transactions may also take a significant financial “hit” due to the malicious parties. For example, c-commerce businesses and financial institutions (e.g., banks) typically bear the cost of stolen goods and disputed transactions.

The consumers may exacerbate this exposure to malicious parties by not keeping their computer “healthy”. For example, “fixes” may be provided by software developers to limit exposure of the user's computer to the malicious parties, such as updates to virus libraries, software patches to fix flaws that may be exploited by malicious parties, and so on. These fixes may therefore be used to keep the computer “healthy” from outside and potentially malicious influences. However, some users may not avail themselves of these fixes and therefore needlessly expose themselves as well as businesses, with which, they transact to these malicious parties.

### SUMMARY

Techniques relating to a statement of health are described herein. In an embodiment, a statement is generated that describes a relative health of a client's resources, such as hardware and/or software resources. The statement is exposed to a service provider over a network, which may be used to manage access of the client to one or more online services of the service provider. For example, the statement may be used by the service provider to provide varying degrees of access to functionality of the online services based on the relative health of the clients.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to perform client statement of health techniques.

FIG. 2 is a flow diagram depicting a procedure in an exemplary implementation in which a statement that describes the relative health of a client's resources is generated.

FIG. 3 is a flow diagram depicting a procedure in an exemplary implementation in which a statement of health is provided to an online service provider that uses the statement to manage access to one or more online services.

FIG. 4 is a flow diagram depicting a procedure in an exemplary implementation in which an e-commerce web site uses a statement of health to manage access to resources of the website.

### DETAILED DESCRIPTION

Overview

Consumers are continually exposed to attacks by malicious parties over the Internet. For instance, viruses may be written that attempt to limit and even prevent use of the functionality of a client, such as software being executed on a computer, hardware resources of the computer, and so on. In another instance, attempts may be made to “snoop” information of the consumer, such as to obtain personally identifiable information that may then be used in fraudulent attempts to purchase goods or services. A variety of other instances may also be encountered by the consumer.

One technique that may be used to limit this exposure is to keep a client used by a consumer to access the Internet “healthy”. For example, software developers may develop patches to correct flaws discovered in software that may be exposed by malicious parties. In another example, the software developers may continue to develop “virus libraries” which may be used to identify new viruses that are being unleashed by the malicious parties. A variety of other examples are also contemplated, such as techniques to combat spyware and other malicious software, i.e., “malware”.

These techniques, however, are limited by the consumer's adoption of them, and therefore consumers that do not avail themselves of these “fixes” may have an “unhealthy” client that is susceptible to attack. Further, a client that is compromised may expose a business, with which, the client interacts to attack. For instance, a malicious party that “snoops” account information of a consumer may use this information to defraud the business.

Techniques are described in which a statement of health may be employed, such as to ensure to a business that the client, with which, the business is interacting is “healthy” and therefore does not needlessly expose the business to malicious parties. In an embodiment, a third-party health service provider is utilized to generate statements of health regarding resources of the client, such as hardware and/or software of the client. These statements of health may be provided to online service providers, with which, the client is to interact to manage that interaction. For instance, the online service provider may provide varying degrees of functionality to clients based on their corresponding relative health. A variety of other embodiments are also contemplated, further discussion of which may be found in relation to the following figures.

In the following discussion, an exemplary environment is first described that is operable to perform techniques related to client statement of health. Exemplary procedures are then described that may be employed in the exemplary environment, as well as in other environments.

Exemplary Environment

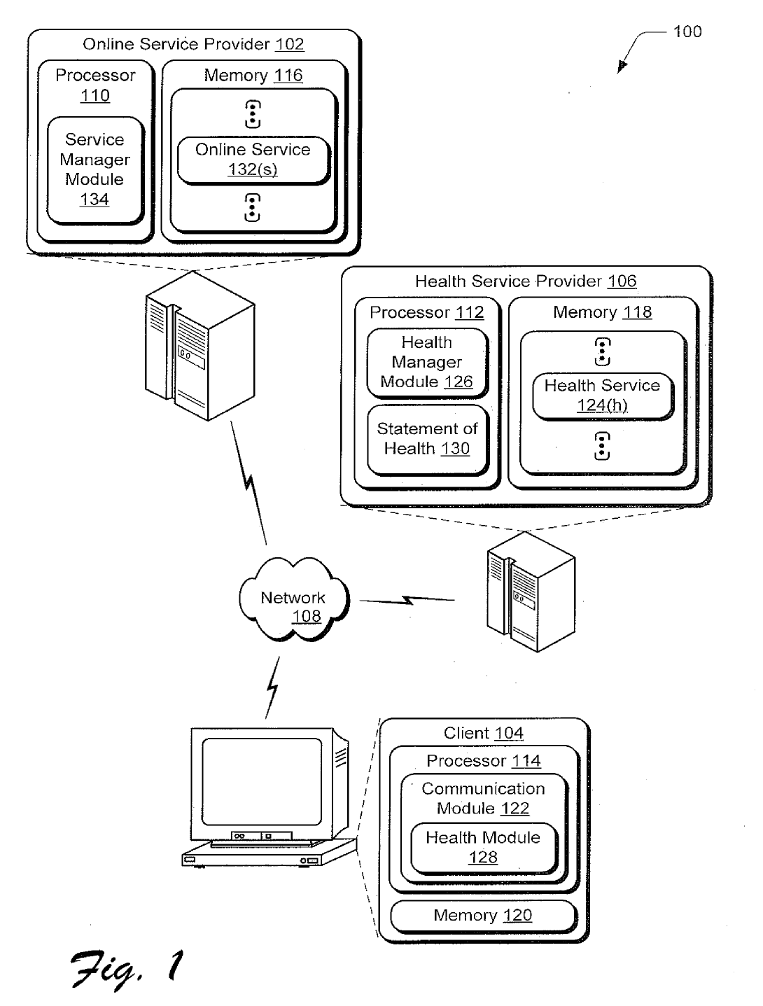

FIG. 1 is an illustration of an environment 100 in an exemplary implementation that is operable to employ client statement of health techniques. The illustrated environment 100 includes an online service provider 102, a client 104 and a health service provider 106 that are communicatively coupled, one to another, via a network 108. In the following discussion, the online service provider 102, the client 104 and the health service provider 106 may be representative of one or more entities, and therefore reference may be made to a single entity (e.g., the client 104) or multiple entities (e.g., the clients 104, the plurality of clients 104, and so on).

The client 104 may be configured in a variety of ways for network 108 access. For example, the client 104 may be configured as software, such as an executable module. The client 104 may also be configured as a computing device as illustrated in FIG. 1, such as a desktop computer, a mobile station, an entertainment appliance, a set-top box communicatively coupled to a display device, a wireless phone, a game console, and so forth. Thus, the client may also range from full resource devices with substantial memory and processor resources (e.g., personal computers, game consoles) to low-resource devices with limited memory and/or processing resources (e.g., traditional set-top boxes, hand-held game consoles).

The online service provider 102 and the health service provider 106 are illustrated in FIG. 1 as being implemented by servers and the client 104 is illustrated as a client device, each of which having respective processors 110, 112, 114 and memory 116, 118, 120. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 166, 118, 120 is shown, respectively, for the online service provider 102, the health service provider 106 and the client 104, a wide variety of types and combinations of memory may be employed, such as random access memory (RAM), hard disk memory, removable medium memory, and other types of computer-readable media.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 106 may be configured to include multiple networks.

The client 104 is illustrated as executing a communication module 122 on the processor 114, which is also storable in memory 120. The communication module 122 is representative of functionality to communicate over the network 108. For example, the communication module 122 may be configured as a web browser that allows the client 104 to “surf” the Internet. In another example, the communication module 122 is configured as a “smart” client module that is configured to provide other network functionality as a part of its operation, such as an instant messaging module, an email module, an online banking module, and so on. A wide variety of other examples are also contemplated.

The client 104, for example, may use the communication module 122 to communicate with the health service provider 106 over the network 108. The health service provider 106 in the illustrated example is representative of a third party service to maintain the “health” of the client 104. For example, the health service provider 106 may include one or more health services 124(h) (where “h” can be any integer from one to “H”) that are managed through execution of the health manager module 126. The health services 124(h) may be configured in a variety of ways, such as functionality to provide protection against viruses and spyware, provide a firewall, de-fragmenting of a hard disk drive, removal of unnecessary files on the client 104, check for and install software updates, provide backup and restore functionality, and so on. The health service provider 106 may provide these health services 124(h) in a variety of ways.

A health module 128, for instance, may be provided by the health service provider 106 to the client 104 over the network 108. The health module 128 is representative of functionality to monitor and maintain the health of the client 104 locally. For example, the health module 128 may be executed locally to perform scans, obtain updates, and so on. The health module 128, for instance, may be executed “in the background” in real time during operation of the client 104. The health module 128 may also be configured to provide data regarding the health of the client 104 to the health service provider 106, which may describe the health of the client 104. In another example, the health service provider 106, itself, scans the client 104 over the network.

Through maintenance of the client 104, the health service provider 106 may serve as a trusted third-party that can “vouch” for the health of the client 104 through use of a statement of health 130, such as to the online service provider 102. The client 104, for instance, may interact with the online service provider 102 over the network 108. The online service provider 102 includes one or more online services 132(s) that are managed through use of a service manager module 134. To protect against “unhealthy” clients that may be compromised by malicious parties, the online service provider 102 may obtain the statement of health 130 from the health service provider 106 (either directly or indirectly through the client 104). The statement of health 130 may indicate the relative health of resources of the client 104, and thus, may be used by the online service provider to manage access by the client 104 to the online services 132(s), further discussion of which may be found in relation to the following procedures.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 116, 118, 120. The features of the statement of health techniques described below are platform-independent, meaning that the techniques may be implemented on a variety of commercial computing platforms having a variety of processors.

Exemplary Procedures

The following discussion describes statement of health techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

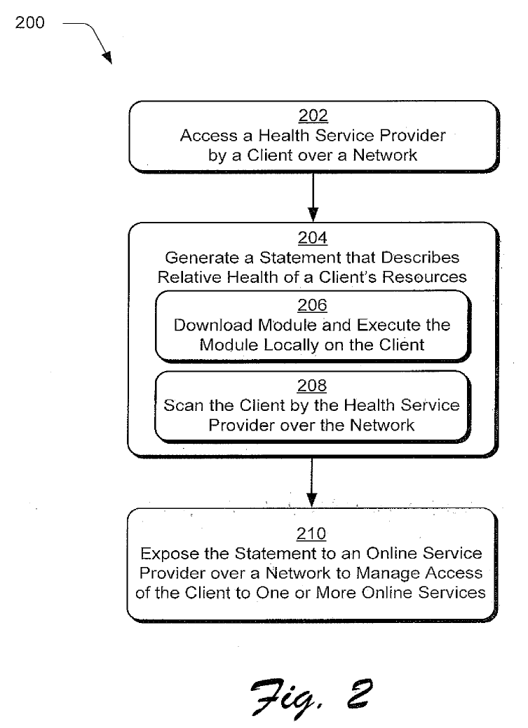

FIG. 2 depicts a procedure 200 in an exemplary implementation in which a statement that describes the relative health of a client's resources is generated. A heath service provider is accessed by a client over a network (block 202). For example, the client 104 may “log on” to the health service provider 106 to utilize one or more of the health services 124(h), such as to obtain a subscription from the health service provider 106 to maintain the client 104.

A statement is generated that describes a relative health of the client's resources (block 204). This statement may be generated in a variety of ways. For example, a module may be downloaded and executed locally on the client (block 206) to monitor health of the client. The health module 128, for instance, may be run in “real time” in the background during operation of the client 104. The health module 128 may be configured to upload data describing the “health” of the client 104 to the health service provider 106, such as at period intervals, by providing a stream of data during operation of the client 104, and so on. Further, the data may describe the current state of the client 104, as well as past states of the client 104, e.g., by storing the data at the health service provider 106. In another example, the client may be scanned by the by the health service provider 106 over the network 108 (block 208). A variety of other examples are also contemplated.

Regardless of how the data is obtained by the health service provider 106, the provider may use this data to generate a statement of health 130 that describes the health of the client. For example, the data may describe a last time that the client 104 updated its virus software, when a last “full” scan of the client for viruses and spyware was performed, which versions of software are maintained by the client 104, and so on. This data may then be used to calculate a relative value of the “health” of the client. The relative value, for instance, may be a binary value (e.g., “healthy” or “not healthy”), numerical scale (e.g., from “0” to “10”), alphabetic (e.g., “A”, “B”, “C”, “D”, F”), and so on.

The statement may then be exposed to an online service provider over a network to manage access of the client to one or more online services (block 210). The statement of health 130, for instance, may be exposed such that the client 104 may obtain the statement when accessing the online service provider 102. In another instance, the statement of health 130 may be exposed to be obtained by the online service provider 102 directly from the health service provider 106 without communicating it through the client 104. Additional discussion of communication of the statement to the online service provider may be found in relation to the following figures.

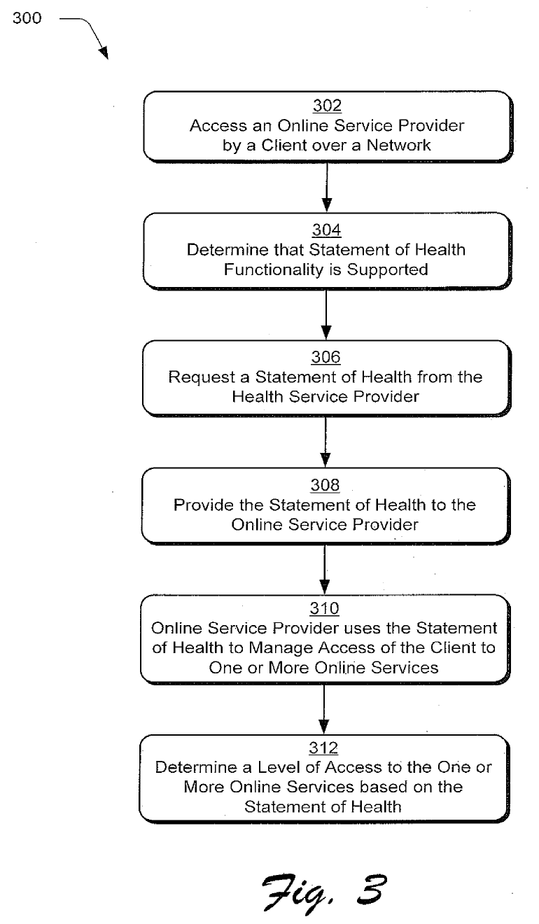

FIG. 3 depicts a procedure 300 in an exemplary implementation in which a statement of health is provided to an online service provider that uses the statement to manage access to one or more online services. An online service provider is accessed by a client over a network (block 302). For example, the client may be configured as a browser that is executed on a computer to access online services that provide web pages. In another example, the client 104 may be configured as a client device as shown in FIG. 1 that executes a communication module 122 to interact with the online services 132(s), such as an e-commerce site. A variety of other examples are also contemplated.

A determination is made that statement of health functionality is supported (block 304). The client 104, for instance, may request a web page from the online service provider 102. The request may include an indication that a statement of health 130 is available from the health service provider 106, such as by including a network address of the health service provider 106. In another instance, the online service provider 102 may query the client 104 to determine whether a statement of health is available, such as by determining that the client 104 includes a health module 128. A variety of other instances are also contemplated.

When the functionality is supported, a statement of health is requested from the health service provider (block 306). The online service provider 102, for example, may request that the client 104 obtain the statement of health 130 from the health service provider 106. In another example, the online service provider 102 may request the statement of health 130 directly from the health service provider 106, such as by using a network address provided by the client 104.

The statement of health is then provided to the online service provider (block 308), such as by communicating it through the client 104 in the first instance, directly to the online service provider 102 in the second instance, and so on.

The online service provider may then use the statement of health to manage access of the client to one or more online services (block 310). The online service provider, for instance, may determine a level of access to the one or more online services based on the statement of health (block 312). For example, the online service provider may grant greater access to the online resources when the client 104 is indicated as “healthy” as opposed to the access granted when the client 104 is “unhealthy”, an example of which may be found in relation to the following figure.

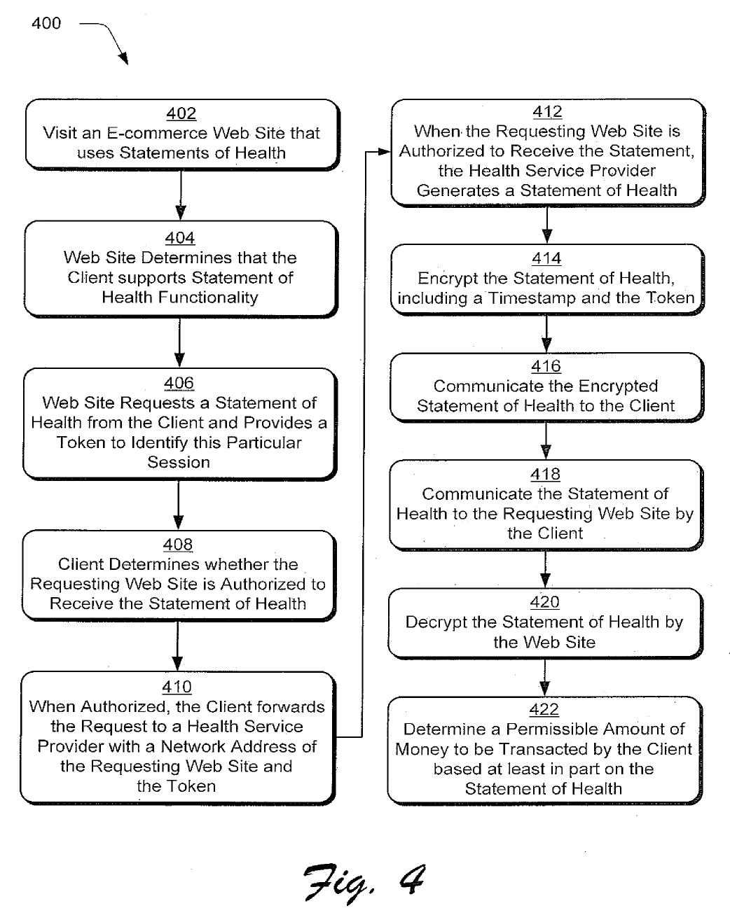

FIG. 4 depicts a procedure 400 in an exemplary implementation in which an e-commerce web site uses a statement of health to manage access to resources of the website. A client visits an e-commerce website that uses statements of health (block 402), such as a banking website. The web site determines that the client supports statement of health functionality (block 404). The web site, for instance, may determine that the client 104 has a health module 128 installed.

The web site then requests a statement of health from the client and provides a token to identify this particular session (block 406). The web site, for instance, may invoke the health module 128 and request a statement of health 130 originated from the health service provider 106. The token may be a random number generated for this particular session.

The client 104 (e.g., the health module 128) may then determine as to whether the requesting web site is authorized to received the statement of health (block 408). For example, the web site may provide a certificate to verify the request. This check, in this example, may be considered a preliminary one, as the actual decision to release or not to release the statement of health 130 may be done by the health service provider 106. However, this preliminary check may be used to “pre-filter” requests to reduce denial of service attacks.

When authorized, the client forwards the request to the health service provider along with a network address of the requesting web site and the token (block 410). The health service provider may then also check to determine whether the online service provider 102 is authorized to receive the statement of health 130 as previously described. When the request web site is authorized to receive the statement, the health service provider generates the statement of health (block 412).

For example, the health manager module 126 may generate the statement of health 130 using data obtained from the client, e.g., from scanning the client 104 by the health manager module 126, through execution of the health module 128 on the client 104 itself, and so on. Thus, in this example the statement is generated in response to the request in order to utilize the most “up-to-date” data available. In another example, however, the statement of health 130 may be pre-generated, such as in response to a periodic provision of the data from the client 104. A variety of other examples are also contemplated.

The statement of health may then by encrypted, including a timestamp and the token (block 414) issued by the requesting web site. By including the token issued by the requesting web site into the encrypted response, “replay attacks” may be minimized, in which, a captured “positive” (e.g., “healthy”) statement of health is submitted for other sites and clients.

The encrypted statement of health is communicated to the client (block 416). In an implementation, the client is unable to discern the contents of the statement of health due to the encryption. The client may then communicate the statement of health to the requesting web site (block 418).

The requesting web site (i.e., the e-commerce web site) may then decrypt the statement of health (block 420) and from it, determine a permissible amount of money to be transacted by the client (block 422). For example, the requesting web site may determine that the client 104 meets the minimal requirement to be “health” and thus is given unrestricted access to the functionality provided by the web site. When the client does not meet the minimal requirements, however, (e.g., an operating system patch is not current, a health module 128 is not up-to-date, and so on), the web site may provided limited functionality to reduce potential damage in case the client 104 is compromised, such as by limiting the amount allowed in the transactions with the e-commerce web site.

Thus, in this example, the health service provider 106 is a third-party entity that provides the client's statement of health. As previously described, the health service provider 106 may use a variety of techniques to determine the “health” of the client 104, such as the data reported by the client, the amount of time that the client 104 has subscribed to the health service provider 106, and other reputation-type criteria. It should be readily apparent that although the statement of health 130 was provided by the health service provider 106 that also provides health services 124(h), this functionality may also be provided by a stand alone service without departing from the spirit and scope thereof.

It should also be apparent that in the above description specific flow of notification and data between the online service provider 102 (e.g., the web site), the client 104 and the health service provider 106 was described, it is just one of numerous contemplated flows. Instead of forwarding each request to the health service provider 106, for instance, the statement of health 130 may be stored on the client 104 and updated on a schedule. The client 104 may then present the statement to requesting sites. Other variations of the flow are also possible, with different flows having slightly different trade-offs of the resilience to attacks by malicious parties, load on the online service provider 102, and disclosure of the traceable machine identity. For instance stronger authentication may be provided by tracking the client, with which, the user uses to login to the online service provider. In this scenario, if the client is “known”, then it could have potentially higher levels of authorization versus a public client that is shared by other users. A variety of other instances are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
generating a statement that describes relative health of a client's resources and
exposing the statement to a service provider over a network to manage access of the client to one or more online services of the service provider.

2. A method as described in claim 1, wherein the generating is performed from data that describes current and past states of the client's resources.

3. A method as described in claim 1, wherein the generating is performed from data that describes when virus scans of the client have been performed and a version of virus identification data was used by the client.

4. A method as described in claim 1, wherein the generating is performed from data that describes whether one or more updates to software were performed by the client.

5. A method as described in claim 1, wherein the generating is performed from data that describes whether the client participated in an online virus attack.

6. A method as described in claim 1, wherein the generating is performed from data that describes network access performed by the client.

7. A method as described in claim 1, wherein:
the exposing is performed such that the statement is accessible by the client; and
the statement is to be provided by the client to the service provider.

8. A method as described in claim 7, wherein content of the statement is not discernable by the client.

9. A method as described in claim 1, wherein the exposing is performed such that the statement is accessible by the service provider without communicating the statement via the client.

10. A method as described in claim 1, wherein the exposing is performed such that the statement is not accessible to another service provider that is not permitted to access the statement.

11. One or more media comprising instructions that are executable on a processor of a client to provide:
data to a health service provider that describes one or more resources of the client; and
an indication to an online service provider that a statement is available, from the health service, that describes relative health of the one or more resources of the client.

12. One or more computer-readable media as described in claim 10, wherein the data provided to the health service provider does not include personally identifiable information of a user of the client.

13. One or more computer-readable media as described in claim 10, wherein the resources include software.

14. One or more computer-readable media as described in claim 10, wherein the indication also includes a network address of the health service provider, via which, the statement is available.

15. One or more computer-readable media as described in claim 10, wherein the instructions are further executable on the processor of the client to provide the statement to the online service provider when requested.

16. One or more computer-readable media as described in claim 15, wherein the statement is encrypted such that content of the statement is not accessible by the client.

17. An apparatus comprising:
a processor; and
memory configured to maintain one or more modules that are executable on the processor to provide varying levels of access to one or more online services to clients based on a statement describing relative health of the respective client that is originated by a third-party service over a network.

18. An apparatus as described in claim 17, wherein the varying levels of access involve an amount of money permitted to be involved in a transaction.

19. An apparatus as described in claim 17, wherein the statement is a cryptographically-signed certificate.

20. An apparatus as described in claim 17, wherein the one or more modules are further executable on the processor to provide the varying levels of access based at least in part on an identity of a user of the client.
